(19) United States
(12) Patent Application Publication
(10) Pub. No.: US 2026/0336182 A1
(43) Pub. Date: Oct. 29, 2026

(54) FLUID APPLICATION METHOD

(71) Applicants: TOYOTA SHATAI KABUSHIKI KAISHA, Kariya-shi, Aichi (JP); HEISHIN Ltd., Kobe-shi, Hyogo (JP)

(72) Inventors: Eiji NAITOU, Aichi (JP); Takuya SUZUKI, Aichi (JP); Junpei FUSE, Shiga (JP); Yuki NAKAGAWA, Shiga (JP)

(73) Assignees: TOYOTA SHATAI KABUSHIKI KAISHA, Kariya-shi, Aichi (JP); HEISHIN Ltd., Kobe-shi, Hyogo (JP)

(21) Appl. No.: 19/104,891

(22) PCT Filed: Oct. 3, 2023
(86) PCT No.: PCT/JP2023/036034

§ 371 Date: Feb. 19, 2025

(30) Foreign Application Priority Data
Oct. 12, 2022 (JP) 2022-163796
Apr. 21, 2023 (JP) 2023-070370

(51) Int. Cl. B29C 48/00; B29L 31/30

(52) U.S. Cl. CPC B29C 48/0022; B29L 2031/30

(57) ABSTRACT

A fluid application method for applying a sealant, which is a highly viscous fluid, to an application surface of a substrate, which is a workpiece, including: a shape-retained portion forming step of forming a shape-retained portion made of the sealant extended from a discharge port of the nozzle to the application surface by discharging the sealant from the nozzle, which is arranged in a position spaced from the application surface with a gap, to be adhered to the application surface; and a shape-retained portion cutting step of cutting the shape-retained portion to be left in an adhesion state on the application surface side by sliding a wire toward the shape-retained portion formed in the shape-retained portion forming step in a first direction crossing the discharge port of the nozzle.

### TECHNICAL FIELD

The present disclosure relates to a technique for applying a fluid.

### BACKGROUND ART

A substrate such as a vehicle body of an automobile is provided with various opening portions such as an opening hole intended for electrodeposition paint removal and an opening hole used for positioning a member for welding. In order to prevent rainwater, dust, sound, and the like from entering through these opening portions, elastically deformable sealing components made of a resin material, a rubber material, and the like are used. The sealing components are pushed and fitted into the opening portions of the substrate to seal the opening portions. Such sealing components are commonly referred to as “plugs”.

In addition, Patent Document 1 below discloses a sealing method in which opening holes are buried with a sealant containing a foaming agent and are closed by foaming the sealant. Such a sealing method has an advantage that it is not necessary to prepare a plurality of types of plugs in advance in accordance with sizes of opening holes having different sizes, and a component cost of the plugs can be reduced.

### PRIOR ART DOCUMENT

### Patent Document

Patent Document 1: JP S61-263827 A

### SUMMARY OF THE INVENTION

### Problems to be Solved by Invention

However, in a case in which the sealing method described above is adopted, it is necessary for a worker to manually perform work of stretching a hand every time for each opening hole in a state of holding the sealant and embedding the sealant in the opening hole. Therefore, there may be a problem that the burden on workers required for the sealing work is large. In particular, since the number of opening holes provided in a vehicle body of an automobile or the like is large and the worker repeats the same posture, such a problem becomes more remarkable. Therefore, there is a demand for a technique capable of easily performing such work. In addition, such a technique is similarly required not only when the opening holes provided in the substrate are sealed with the sealant but also when a highly viscous fluid such as a sealant is applied to application surfaces of various workpieces.

An object of the present disclosure is to provide a technique effective for easily applying a highly viscous fluid to an application surface of a workpiece.

### Means for Solving Problem

One aspect of the present disclosure is
a fluid application method for applying a highly viscous fluid to an application surface of a workpiece, the fluid application method comprising:
a shape-retained portion forming step of forming a shape-retained portion made of the fluid extended from a discharge port of the nozzle to the application surface by discharging the fluid from the nozzle, which is arranged in a position spaced from the application surface with a gap, to be adhered to the application surface; and
a shape-retained portion cutting step of cutting the shape-retained portion to be left in an adhesion state on the application surface side by sliding a wire toward the shape-retained portion formed in the shape-retained portion forming step in a transverse direction crossing the discharge port of the nozzle.

### EFFECTS OF THE INVENTION

The application method of the aspect described above is the method for applying the highly viscous fluid on the application surface of the workpiece. This application method includes at least the shape-retained portion forming step and the shape-retained portion cutting step. In the shape-retained portion forming step, the highly viscous fluid is discharged from the nozzle, which is arranged in a position spaced from the application surface of the workpiece with a gap, to be adhered to the application surface. Thus, the shape-retained portion made of the highly viscous fluid extended from a discharge port of the nozzle to the application surface of the workpiece is formed. In addition, in the shape-retained portion cutting step, the wire is slid toward the shape-retained portion formed in the shape-retained portion forming step in a transverse direction crossing the discharge port of the nozzle. Thus, the shape-retained portion is cut and is to be left in an adhesion state on the application surface side of the workpiece. At this time, if a dimension of the gap between the application surface of the workpiece and the nozzle is changed in accordance with the purpose, an application thickness of the shape-retained portion can be adjusted in any manner.

Since the fluid has high viscosity, in the shape-retained portion forming step, the fluid adheres to the application surface of the workpiece due to its adhesion performance to form the shape-retained portion extending from the discharge port of the nozzle to the application surface, and serves a characteristic that a shape of the shape-retained portion can be maintained. In addition, such a highly viscous fluid serves a characteristic that the shape-retained portion hardly drips from the application surface once the shape-retained portion cut in the shape-retained portion cutting step adheres to the application surface of the workpiece. Therefore, even if the shape-retained portion is affected by gravity, vibration, or the like over time, a phenomenon of peeling or dripping from the application surface of the workpiece hardly occurs. As a result, an application state of the fluid on the application surface of the workpiece can be maintained.

According to the application method of the above aspect, the shape-retained portion extending from the discharge port of the nozzle to the application surface of the workpiece can be cut by the wire to perform work of applying the fluid. Thus, a worker can easily perform the work of applying the fluid. In addition, since the fluid is applied with the gap between the application surface of the workpiece and the nozzle, the work of applying the fluid is hardly affected by a shape of the application surface of the workpiece, and is highly versatile.

As described above, according to the above aspect, it is possible to provide the technique effective for easily applying the highly viscous fluid to the application surface of the workpiece.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an overall configuration of a sealing facility according to a first embodiment.

FIG. 2 is a cross-sectional view illustrating a structure of a distal end portion of a nozzle device of the first embodiment.

FIG. 3 is a graph illustrating a correlation between viscosity and a shear rate regarding characteristics of a sealant used in the first embodiment.

FIG. 4 is a flowchart of an application method of the first embodiment.

FIG. 5 is a time chart illustrating an operation timing for each member in the application method of the first embodiment.

FIG. 6 is a cross-sectional view illustrating a state of the nozzle device of FIG. 2 during execution of a first step in FIG. 4.

FIG. 7 is a cross-sectional view illustrating a state of the nozzle device of FIG. 2 during execution of a second step in FIG. 4.

FIG. 8 is a cross-sectional view illustrating a state of the nozzle device of FIG. 2 during execution of a third step in FIG. 4.

FIG. 9 is a cross-sectional view illustrating a state of the nozzle device of FIG. 2 during execution of a fourth step in FIG. 4.

FIG. 10 is a cross-sectional view illustrating a state of the nozzle device of FIG. 2 during execution of a fifth step in FIG. 4.

FIG. 11 is a cross-sectional view illustrating a structure of a distal end portion of a nozzle device of a second embodiment.

FIG. 12 is a flowchart of an application method of the second embodiment.

FIG. 13 is a time chart illustrating the operation timing for each member in the application method of the second embodiment.

FIG. 14 is a cross-sectional view illustrating a state of the nozzle device of FIG. 11 during execution of a first step in FIG. 12.

FIG. 15 is a cross-sectional view illustrating a state of the nozzle device of FIG. 11 during execution of a second step in FIG. 12.

FIG. 16 is a cross-sectional view illustrating a state of the nozzle device of FIG. 11 during execution of a third step in FIG. 12.

FIG. 17 is a cross-sectional view illustrating a state of the nozzle device of FIG. 11 during execution of a fourth step and a fifth step in FIG. 12.

FIG. 18 is a cross-sectional view illustrating a state of the nozzle device of FIG. 11 during execution of a sixth step in FIG. 12.

FIG. 19 is a flowchart of an application method of a third embodiment.

FIG. 20 is a cross-sectional view illustrating a state of the nozzle device of FIG. 2 during execution of a second step in FIG. 19

FIG. 21 is a cross-sectional view illustrating a state of the nozzle device of FIG. 2 during execution of an additional second step in FIG. 19.

FIG. 22 is a cross-sectional view illustrating a state of the nozzle device of FIG. 2 during execution of a third step in FIG. 19.

FIG. 23 is a cross-sectional view illustrating a state of the nozzle device of FIG. 2 during execution of a fourth step in FIG. 19.

FIG. 24 is a cross-sectional view illustrating a state of the nozzle device of FIG. 2 during execution of a fifth step in FIG. 19.

### DETAILED DESCRIPTION OF THE INVENTION

Preferred embodiments of the aspect described above will be described below.

In the fluid application method according to the aspect described above, it is preferable that in the shape-retained portion forming step, the fluid is discharged so as to have a protrusion protruded from the discharged port of the nozzle, thereafter, is sucked to allow the protrusion to flow in a suction direction, and a front surface of the protrusion is pressed against the application surface to have the application surface adhered thereto.

When the highly viscous fluid is discharged from the nozzle, sticking resistance acts between the fluid and an inner surface of the nozzle. Therefore, the protrusion of the fluid is formed such that a portion closer to the center of the nozzle first swells in a protruding direction and descends from the portion toward a portion on the outer peripheral side of the nozzle. Thereafter, also when the fluid is sucked, sticking resistance acts between the fluid and the inner surface of the nozzle. At this time, a portion closer to the center of the nozzle in the protrusion of the fluid is first drawn in the suction direction. Therefore, the degree of unevenness of the front surface of the protrusion can be suppressed to be small, and adhesion performance of the fluid when the front surface of the protrusion is pressed against the application surface of the workpiece can be improved.

In the fluid application method according to the aspect described above, it is preferable that in the shape-retained portion forming step, the fluid is sucked until the front surface of the protrusion reaches a flat state.

According to this application method, when the fluid is attached to the application surface of the workpiece, the front surface of the protrusion of the fluid can be pressed against the application surface in the flat state. Thus, it is possible to further improve the adhesion performance of the fluid with respect to the application surface of the workpiece. In addition, since the front surface of the protrusion of the fluid is brought into the flat state, it is possible to adjust the protrusion to a planned protruding height so as not to protrude too much from the discharge port of the nozzle. Thus, cutting performance of the shape-retained portion by the wire can be stabilized, and cutting failure of the shape-retained portion can be prevented.

For example, in a case where the application surface of the workpiece is an surface having an opening and the opening is closed and sealed by the fluid, it is not necessary to excessively press the front surface of the protrusion against the surface having the opening in order to secure desired sealing performance by sucking the fluid such that the front surface of the protrusion is in the flat state. Thus, it is possible to suppress the fluid from excessively entering and biting into the opening of the workpiece. Furthermore, since the protrusion is suppressed from biting into the opening of the workpiece, the shape-retained portion finally remaining on the application surface side of the workpiece by cutting can be formed into a shape having a constant thickness and good appearance. As a result, the opening of the workpiece can be closed with a minimum amount of the fluid, a material cost of the fluid can be reduced, and a weight increase of the workpiece can be suppressed.

In the fluid application method according to the aspect described above, it is preferable that in the shape-retained portion cutting step after forming the shape-retained portion, a nozzle operation of moving the nozzle away from the application surface of the workpiece along an axis line of the nozzle and a wire operation of sliding the wire in the transverse direction are performed in an interlocking manner.

In this application method, the nozzle operation is an operation of applying a tensile load to the shape-retained portion by moving the nozzle away from the application surface of the workpiece along the axis line of the nozzle after the shape-retained portion is formed. On the other hand, the wire operation is an operation of cutting the shape-retained portion receiving the tensile load by the wire. Since the nozzle operation and the wire operation are performed in an interlocking manner, it is possible to prevent the shape-retained portion after the cutting from recombining with the fluid on the nozzle side.

In the fluid application method according to the aspect described above, it is preferable that in the shape-retained portion forming step, the shape-retained portion is formed by adhesion of the fluid to the application surface in an inclined state in which the nozzle is obliquely arranged with respect to the application surface of the workpiece in such a manner that the gap becomes maximum on a side where the wire starts to slide, and in the shape-retained portion cutting step, the nozzle operation and the wire operation are performed in parallel.

In this application method, the nozzle is brought into the inclined state when the fluid is discharged from the nozzle toward the application surface of the workpiece in the shape-retained portion forming step. This inclined state is a state in which the nozzle is obliquely arranged such that the gap with the application surface of the workpiece becomes maximum on the slide start side of the wire. Therefore, the shape-retained portion is formed between the discharge port of the nozzle in the inclined state and the application surface of the workpiece. In the subsequent shape-retained portion cutting step, the wire operation of cutting the shape-retained portion receiving the tensile load due to the nozzle operation by the wire is performed while performing the nozzle operation of moving the nozzle in the inclined state away from the application surface of the workpiece along the axis line of the nozzle. That is, the nozzle operation and the wire operation are performed in parallel. Thus, the time required for the shape-retained portion cutting step can be shortened. If the nozzle is arranged such that the axis line of the nozzle is perpendicular to the application surface of the workpiece when the nozzle operation and the wire operation are performed in parallel, a thickness of the shape-retained portion that adheres to the application surface of the workpiece and finally remains is thicker on a slide end side of the wire than that on the slide start side of the wire. On the other hand, if the nozzle operation is performed with the nozzle in the inclined state as described above, the shape-retained portion having a constant thickness can be formed even when the nozzle operation and the wire operation are performed in parallel.

In the fluid application method according to the aspect described above, it is preferable that the application surface of the workpiece is a surface having an opening.

According to this application method, when the application surface is a surface having the opening, the opening can be sealed with the fluid.

Hereinafter, specific embodiments for carrying out a technique of applying a sealant to a substrate constituting a vehicle body of an automobile so as to seal an opening thereof will be described with reference to the drawings.

In the drawings for describing the present embodiments, the vertical direction is indicated by an arrow X, and the horizontal direction is indicated by an arrow Y unless otherwise specified. In addition, two directions opposite to each other in a direction in which the axis line of the nozzle extends are referred to as a first direction X1 and a second direction X2, and two directions orthogonal to the axis line of the nozzle and opposite to each other are referred to as a first direction Y1 and a second direction Y2.

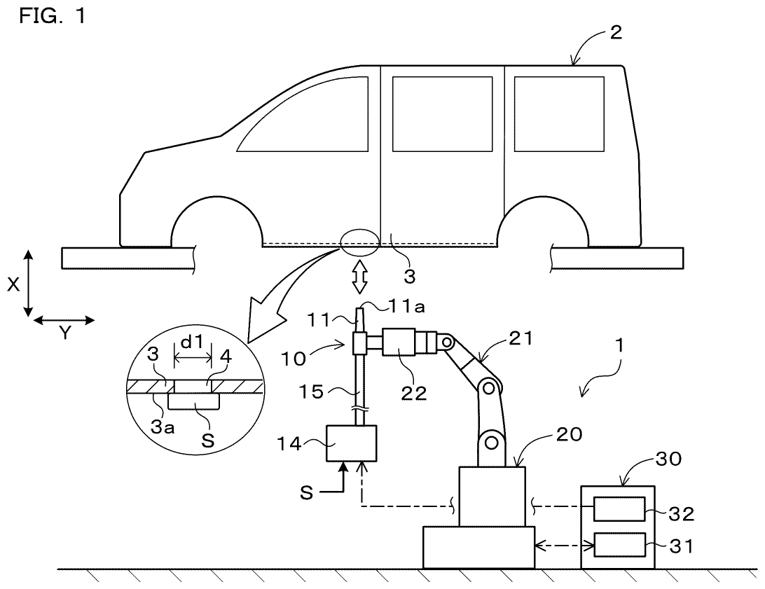

As shown in FIG. 1, a sealing facility 1 according to the present embodiment is configured to seal an opening 4 formed in a substrate 3 constituting a vehicle body 2. At this time, an application surface 3a of the substrate 3, which is a workpiece, is a surface having the opening 4. Therefore, the opening 4 is sealed by applying a sealant S to the application surface 3a so as to close the opening 4. Here, examples of the substrate 3 typically include a member constituting an underbody of the vehicle body 2 and a substrate such as a reinforcement.

In work of applying the sealant S to the application surface 3a of the substrate 3, the vehicle body 2 is arranged in advance such that a portion corresponding to the substrate 3 extends substantially in the horizontal direction Y. The opening 4 typically includes an opening hole, a through hole, a recess, and the like. In the present embodiment, a through hole having an opening diameter d1 with a circular cross-sectional shape is exemplified as the opening 4. On the other hand, the cross-sectional shape of the opening 4 is not limited to a circular shape, and the cross-sectional shape of the opening 4 may be other than a circular shape as necessary.

### 1. The Entire Configuration of the Sealing Facility 1

As shown in FIG. 1, the sealing facility 1 according to a first embodiment mainly includes a nozzle device 10, a robot 20, and a control device 30 as constituent elements thereof.

The nozzle device 10 includes a nozzle 11, a pump 14, and a supply pipe 15 that connects the nozzle 11 and the pump 14. The pump 14 is configured to discharge the sealant S, which is a highly viscous fluid, at a high pressure. The sealant S discharged by the pump 14 is pressure-fed to the nozzle 11 through the supply pipe 15, and is discharged to the outside so as to protrude from a discharge port 11a of the nozzle 11. Although details will be described later, in the present embodiment, the nozzle 11 is brought close to the opening 4 from below in the vertical direction X of the substrate 3, and then the sealant S discharged from the discharge port 11a of the nozzle 11 is applied to the opening 4.

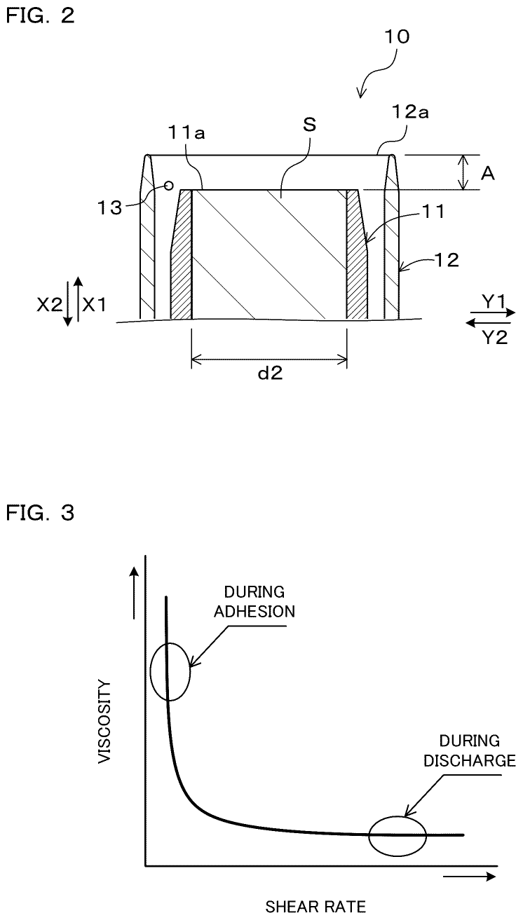

When the first direction X1 (see FIG. 2) is a “protruding direction” of the sealant S and the second direction X2 (see FIG. 2), which is a direction opposite to the protruding direction, is a “suction direction”, the pump 14 of the present embodiment is configured to be capable of switching between a first operation of discharging the sealant S such that a part of the sealant S is pushed out from the discharge port 11a of the nozzle 11 in the protruding direction X1 to form a protrusion and a second operation of sucking the sealant S such that the protrusion of the sealant S flows in the suction direction X2.

The nozzle device 10 is held by an arm distal end portion 22 of a robot arm 21 of the robot 20. The robot 20 is configured as a multi-axis robot in which a plurality of drive shafts are provided in the robot arm 21. Both the robot 20 and the pump 14 are electrically connected to the control device 30.

The control device 30 includes a known CPU, a known memory, a known input/output unit, and the like. The control device 30 includes a robot control unit 31 and a pump control unit 32.

The robot control unit 31 has a function of controlling the robot 20. According to the robot control unit 31, the robot 20 is controlled such that the arm distal end portion 22 of the robot arm 21 moves according to a movement trajectory taught in advance. Thus, the nozzle device 10 can be adjusted to a desired posture. In addition, the pump control unit 32 also has a function of controlling the pump 14. According to the pump control unit 32, a discharge flow rate of the sealant S discharged from the discharge port 11a of the nozzle 11 is controlled.

### 2. The Structure of Distal End Portion of the Nozzle Device 10

As shown in FIG. 2, the nozzle device 10 of the first embodiment includes a guide member 12 and a wire 13 in addition to the nozzle 11.

The nozzle 11 is sized to have an inner diameter d2 being equal to or larger than an opening diameter d1 (see FIG. 1) of the opening 4. Here, the relationship between the opening diameter dl and the inner diameter d2 is preferably determined such that an overlapping margin between the sealant S and an opening edge of the opening 4 can be secured by 0.1 [mm] or more. As an example, when it is assumed that the nozzle 11 and the opening 4 are arranged with their centers coinciding with each other, the inner diameter d2 of the nozzle 11 can be set to be equal to or larger than a value obtained by adding 0.2 [mm] to the opening diameter d1 of the opening 4. Thus, the sealant S can be prevented from penetrating through the opening 4, and the sealant S can be reliably held on the application surface 3a side of the substrate 3. The guide member 12 is a cylindrical member having a diameter larger than that of the nozzle 11, and is provided around the nozzle 11 concentrically with the nozzle 11. Therefore, the axes of the nozzle 11 and the guide member 12 coincide with each other. A flow path cross-sectional shape of the nozzle 11 is not particularly limited, and any flow path cross-sectional shape can be adopted as necessary.

The guide member 12 has a function of determining a positional relationship between the opening 4 of the substrate 3 and the discharge port 11a of the nozzle 11 in the vertical direction. This function is achieved by pressing a distal end portion 12a of the guide member 12 against the application surface 3a of the substrate 3. At this time, the guide member 12 has a structure in which the distal end portion 12a thereof protrudes from the discharge port 11a of the nozzle 11 in the first direction X1 by a protruding height A. The protruding height A is constant over the entire circumference of the nozzle 11. In addition, the guide member 12 is configured to support the nozzle 11 so as to be relatively movable in the first direction X1 and the second direction X2 in FIG. 2.

The wire 13 is provided in the vicinity of the discharge port 11a of the nozzle 11. The wire 13 is typically a member in a wire form or a fishing line form having a uniform cross-sectional shape. The cross-sectional shape of the wire 13 is not particularly limited, and any cross-sectional shape such as a circular shape, an elliptical shape, and a polygonal shape can be adopted. The wire 13 is configured to be capable of reciprocating in a direction (first direction Y1 and second direction Y2) crossing the discharge port 11a by a wire drive mechanism (not shown). According to this configuration, the sealant S protruding from the discharge port 11a of the nozzle 11 can be cut by the wire 13. At this time, the wire 13 preferably slides along the discharge port 11a in an abutment state with no gap formed against the discharge port 11a of the nozzle 11, that is, in a so-called “zero touch” state. This makes it possible to smooth the cut surface of the sealant S.

### 3. Characteristics of the Sealant S

The sealant S used in the present embodiment is an example of the highly viscous fluid. The sealant S is a resin (for example, a resin such as vinyl chloride)-based sealant having fluidity at normal temperature and a static viscosity for retaining a shape after application at the normal temperature. The sealant S preferably has thixotropy in order to improve fluidity at the normal temperature. The “normal temperature” as used herein typically includes a temperature within a range of about 5 to 40 [° C.].

As shown in FIG. 3, the “thixotropy” of the sealant S refers to a characteristic in which a viscosity decreases as a shear rate increases, and the viscosity increases as the shear rate decreases or as time elapses after the application of a shear force is stopped. The sealant S has, for example, thixotropy such that the shear rate is in a range of 60 to 10,000 [s⁻¹] and the viscosity is in a range of 30 to 2 [Pa·s] at the normal temperature of 20 [° C.]. According to such a thixotropy, the viscosity of the sealant S is low in a region where the shear rate is relatively high, and the viscosity is high in a region where the shear rate is relatively low. When the sealant S is discharged from the nozzle 11, discharge pressure by the pump 14 is applied, so that the shear rate of the sealant S flowing through the nozzle 11 increases. At this time, since the viscosity of the sealant S temporarily decreases, a constant level of fluidity of the sealant S can be maintained. Therefore, discharge performance of the sealant S in the nozzle 11 can be improved. On the other hand, since no external force acts on the sealant S, which been discharged from the discharge port 11a of the nozzle 11 and adhered to the application surface of the substrate 3, the shear rate of the sealant S is lower than that at the time of discharge. At this time, since the viscosity of the sealant S increases, desired adhesion performance and shape retention performance of the sealant S can be secured. Therefore, the phenomenon that the sealant S once adhering to the application surface 3a of the substrate 3 is peeled off or drips from the application surface 3a of the substrate 3 hardly occurs.

Next, an application method of the first embodiment will be described with reference to FIGS. 1 and 4 to 10. This application method is a method of applying the sealant S to the application surface 3a of the substrate 3 so as to seal the opening 4 using the sealing facility 1 having the above configuration, and is roughly divided into a shape-retained portion forming step, a shape-retained portion cutting step.

### (Shape-Retained Portion Forming Step)

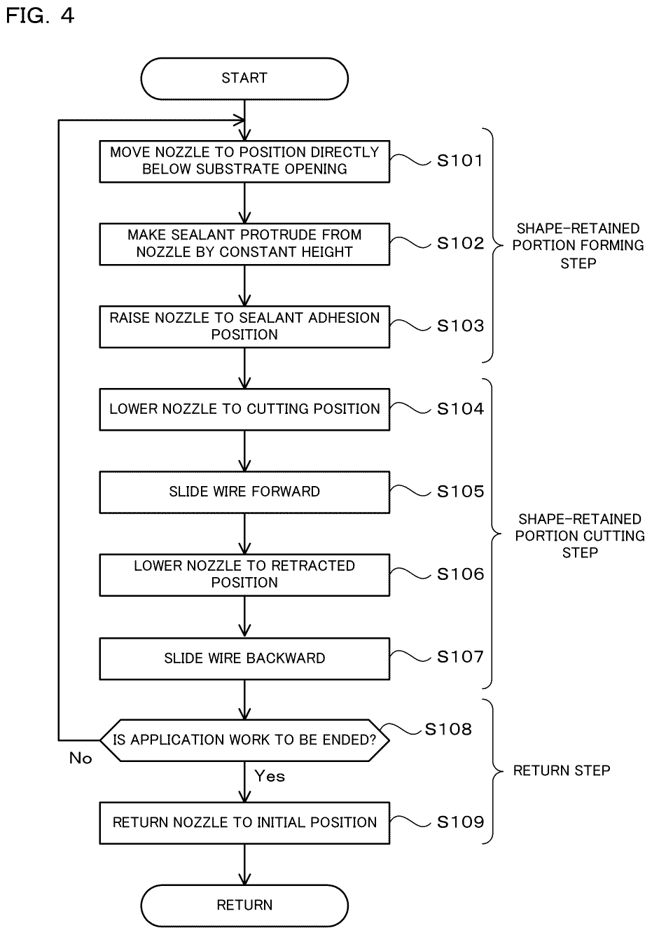

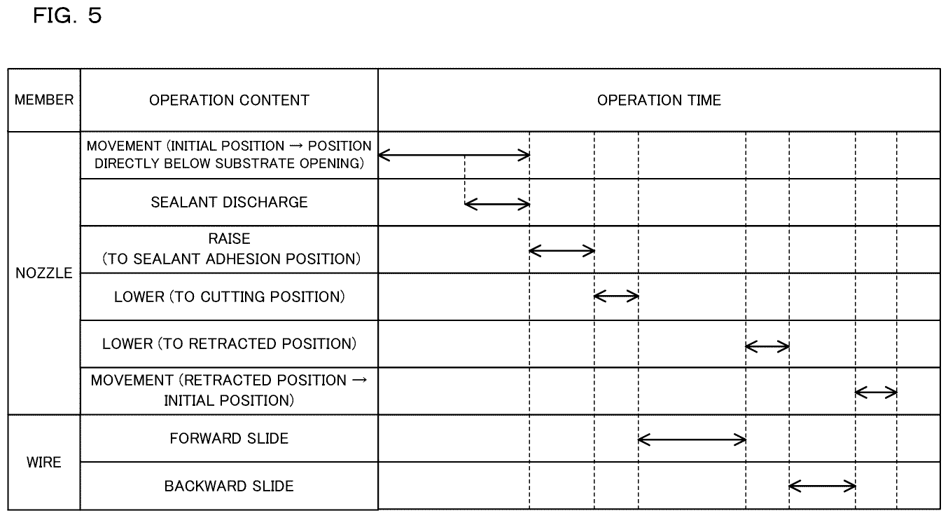

The shape-retained portion forming step can be performed by sequentially performing steps from a first step S101 to a third step S103 in FIG. 4 according to a time schedule in FIG. 5.

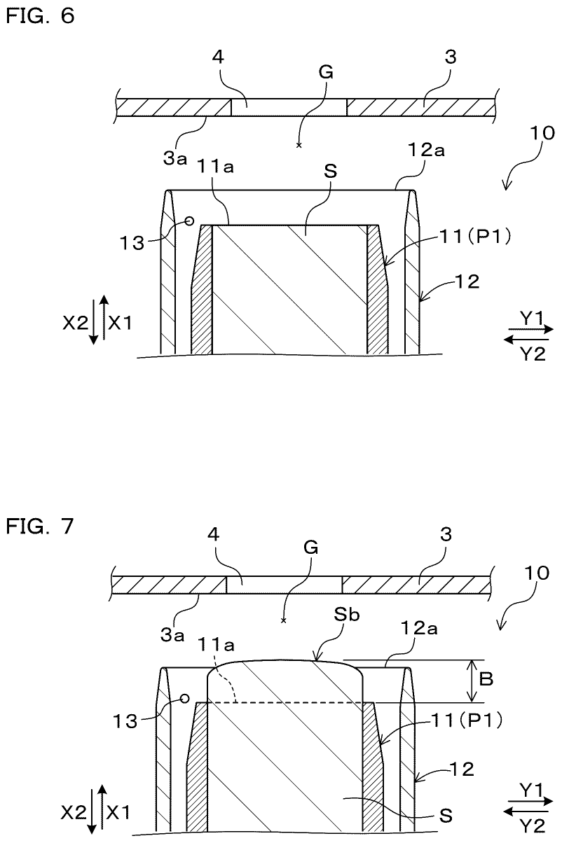

The first step S101 is a step of moving the nozzle 11 from an initial position (not shown) to a position P1 directly below the substrate opening in FIG. 6. When the sealing facility 1 having the above configuration is used, the first step S101 can be executed by outputting a control signal from the robot control unit 31 of the control device 30 to the robot 20 to adjust a posture of the robot arm 21 (see FIG. 1). In the following description, this control is simply referred to as “robot control”. According to the first step S101, the nozzle 11 is moved to the position P1 directly below the substrate opening, such that the discharge port 11a is arranged upward so as to face the opening 4 with a predetermined distance from the opening (see FIG. 6).

The second step S102 is a sealant discharging step of causing the sealant S to protrude from the discharge port 11a of the nozzle 11 by a constant height. When the sealing facility 1 having the above configuration is used, the second step S102 can be executed by outputting a control signal from the pump control unit 32 of the control device 30 to the pump 14 to discharge a constant amount of the sealant S from the discharge port 11a of the nozzle 11. At this time, the above first operation of the pump 14 is executed. According to the second step S102, the nozzle 11 is brought into a state where the sealant S protrudes upward from the discharge port 11a by a protruding height B while being held at the position P1 directly below the substrate opening (see FIG. 7). The protruding height B of a protrusion Sb of the sealant S at this time is preferably set as a dimension by which the sealant S protrudes to a higher location than the distal end portion 12a of the guide member 12. This enables the sealant S to reliably adhere to the application surface 3a of the substrate 3 in the subsequent third step S103.

As shown in a time chart of FIG. 5, it is preferable to execute the second step S102 before the nozzle 11 reaches the position P1 directly below the substrate opening in the first step S101. In the present embodiment, the first step S101 and the second step S102 are scheduled to be completed substantially simultaneously. Thus, the time required for completion of the second step S102 can be shortened.

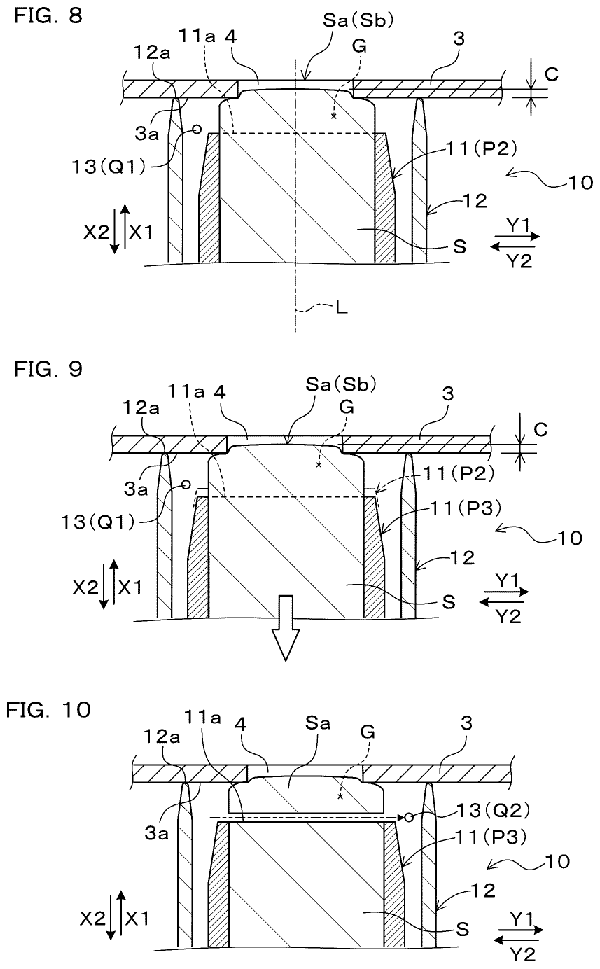

Following the second step S102, the third step S103 is a step of raising the nozzle 11 in the first direction X1 from the position P1 directly below the substrate opening in FIG. 7 to a sealant adhesion position P2 in FIG. 8. This third step S103 can be executed by the robot control described above. As shown in FIG. 8, according to the third step S103, the distal end portion 12a of the guide member 12 abuts on the application surface 3a of the substrate 3, whereby the nozzle 11 is positioned with respect to the opening 4 of the substrate 3, and a height of a gap G in the vertical direction is set to a planned height. At this time, the nozzle 11 is arranged such that an axis line L of the nozzle 11 is perpendicular to the application surface 3a of the substrate 3. In addition, when the nozzle 11 reaches the sealant adhesion position P2, the sealant S adheres to the application surface 3a of the substrate 3 in a state of entering the opening 4 by a protruding height C from the distal end portion 12a of the guide member 12. Then, the protrusion Sb of the sealant S protruding from the discharge port 11a of the nozzle 11 forms a shape-retained portion Sa extending from the discharge port 11a to the application surface 3a while maintaining a constant shape.

As described above, the shape-retained portion forming step of the present embodiment is a step of forming the shape-retained portion Sa in which the protrusion Sb of the sealant S extends from the discharge port 11a of the nozzle 11 to the application surface 3a by discharging the sealant S from the nozzle 11, arranged on the application surface 3a of the substrate 3 with the gap G, to adhere to the application surface 3a.

### (Shape-Retained Portion Cutting Step)

The shape-retained portion cutting step is a step after the shape-retained portion forming step, and can be performed by sequentially performing steps from a fourth step S104 to a seventh step S107 in FIG. 4 according to the time schedule of FIG. 5.

The fourth step S104 is a step of lowering the nozzle 11 in the second direction X2 from the sealant adhesion position P2 (position indicated by the two-dot chain line) to a cutting position P3 (position indicated by the solid line) in FIG. 9. At this time, the nozzle 11 is lowered in the second direction X2 along the axis line L of the nozzle 11 with respect to the guide member 12 in a state where the abutment between the distal end portion 12a of the guide member 12 and the application surface 3a of the substrate 3 is maintained. As shown in FIG. 9, the shape-retained portion Sa of the sealant S slightly extends by receiving a tensile load corresponding to a lowering amount of the nozzle 11 according to the fourth step S104.

Following the fourth step S104, the fifth step S105 is a step of sliding the wire 13 forward. As shown in FIG. 10, according to the fifth step S105, the wire 13 slides forward in the first direction Y1 from a first position Q1 (see FIG. 9) to a second position Q2, whereby the shape-retained portion Sa is cut and separated from the nozzle 11 side. At this time, since the shape-retained portion Sa is cut while receiving the tensile load, the shape-retained portion Sa after the cutting can be prevented from recombining with the sealant S on the nozzle 11 side. Therefore, the shape-retained portion Sa remains on the substrate 3 side while adhering to the application surface 3a of the substrate 3. As a result, the opening 4 is sealed by the shape-retained portion Sa remaining on the substrate 3 side.

In the above description, a state in which a part of the shape-retained portion Sa has entered the opening 4 (hereinafter, referred to as an “entry state”) is formed in the shape-retained portion forming step, and thereafter, the entry state of the shape-retained portion Sa is maintained is exemplified as shown in FIGS. 8 to 10, but it is not essential to form the entry state and maintain the entry state. For example, in the shape-retained portion forming step, a state in which the front surface of the shape-retained portion Sa is substantially flush with the application surface 3a of the substrate 3 (hereinafter, referred to as a “non-entry state”) may be formed, and thereafter, the non-entry state of the shape-retained portion Sa may be maintained. Alternatively, after the entry state of the shape-retained portion Sa is formed in the shape-retained portion forming step, a state of the shape-retained portion Sa may change from the entry state to the non-entering state in the shape-retained portion cutting step. When the shape-retained portion Sa is finally in the entry state, a portion of the shape-retained portion Sa protruding into the opening 4 adheres to an inner peripheral surface of the opening 4, so that an effect that the shape-retained portion Sa is hardly peeled off from the application surface 3a of the substrate 3 can be obtained. On the other hand, when the shape-retained portion Sa is finally in the non-entry state, it is possible to prevent the shape-retained portion Sa from becoming too thick and to suppress the mass of the shape-retained portion Sa to be low.

Following the fifth step S105, the sixth step S106 is a step of lowering the nozzle 11 in the second direction X2 from the cutting position P3 to a retracted position (not shown) lower than the cutting position P3 in FIG. 10. This sixth step S106 can be executed by the robot control described above. According to the sixth step S106, an effect of preventing the shape-retained portion Sa after the cutting from recombining with the sealant S on the nozzle 11 side can be further enhanced.

The seventh step S107 is a step of sliding the wire 13 backward in the second direction Y2 from the second position Q2 (see FIG. 10) to the first position Q1 (see FIG. 6). According to the seventh step S107, the wire 13 can be set in preparation for the next cutting.

As described above, the shape-retained portion cutting step of the present embodiment is a step of sliding the wire 13 in the first direction Y1 crossing the discharge port 11a of the nozzle 11 with respect to the shape-retained portion Sa formed in the shape-retained portion forming step to cut the shape-retained portion Sa and causing the shape-retained portion Sa to remain on the application surface 3a side in the adhesion state. In addition, in the shape-retained portion cutting step of the present embodiment, the nozzle operation of moving the nozzle 11 away from the application surface 3a of the substrate 3 is followed by the wire operation of sliding the wire 13 forward in the first direction Y1 performed in an interlocking manner. The term “interlocking” as used herein refers to an embodiment in which the wire operation is performed following the nozzle operation after the nozzle operation is ended as in the first embodiment.

### (Return Step)

The return step is a step after the shape-retained portion cutting step, and can be performed by sequentially performing an eighth step S108 and a ninth step S109 in FIG. 4 according to the time schedule in FIG. 5.

The eighth step S108 is a step of determining whether or not to end application step on the basis of a predetermined work schedule. The step proceeds to the ninth step S109 in a case where the application step is to be ended (if “Yes” in the eighth step S108), and the step returns to the first step S101 in the other case (if “No” in the eighth step S108). Returning to the first step S101, the nozzle 11 is moved to the position P1 directly below the substrate opening of the next planned site. Thereafter, the step from the second step S102 to the seventh step S107 is similarly executed for the site.

The ninth step S109 is a step of returning the nozzle 11 at the retracted position to the initial position by the robot control described above. According to the ninth step S109, both the nozzle 11 and the wire 13 are set to the standby state for the next application step.

According to the first embodiment described above, the following operational effects can be obtained.

In the application method of the first embodiment, in the shape-retained portion forming step, the highly viscous sealant S is discharged from the nozzle 11, which is arranged in a position spaced from the application surface 3a of the substrate 3 with the gap G, to be adhered to the application surface 3a. Thus, the shape-retained portion Sa made of the highly viscous fluid S extended from a discharge port 11a of the nozzle 11 to the application surface 3a of the substrate 3 is formed. In addition, in the shape-retained portion cutting step, the wire 13 is slid toward the shape-retained portion Sa formed in the shape-retained portion forming step in a first direction Y1 crossing the discharge port 11a of the nozzle 11. Thus, the shape-retained portion Sa is cut and is to be left in an adhesion state on the application surface 3a side of the substrate 3. At this time, if a dimension of the gap between the application surface 3a of the substrate 3 and the nozzle 11 is changed in accordance with the purpose, an application thickness of the shape-retained portion Sa can be adjusted in any manner.

Since the sealant S is the highly viscous fluid, in the shape-retained portion forming step, the sealant S adheres to the application surface 3a of the substrate 3 due to its adhesion performance to form the shape-retained portion Sa extending from the discharge port 11a of the nozzle 11 to the application surface 3a, and serves a characteristic that a shape of the shape-retained portion Sa can be maintained. In addition, such a highly viscous sealant S serves a characteristic that the shape-retained portion Sa hardly drips from the application surface 3a once the shape-retained portion Sa cut in the shape-retained portion cutting step adheres to the application surface 3a of the substrate 3. Therefore, even if the shape-retained portion Sa is affected by gravity, vibration, or the like over time, the phenomenon of peeling or dripping from the application surface 3a of the substrate 3 hardly occurs. As a result, an application state of the sealant S on the application surface 3a of the substrate 3 can be maintained.

According to the application method of the first embodiment, the shape-retained portion Sa extending from the discharge port 11a of the nozzle 11 to the application surface 3a of the substrate 3 can be cut by the wire 13 to perform the work of applying the sealant S. Thus, a worker can easily perform the work of applying the sealant S. In addition, since the sealant S is applied with the gap G between the application surface 3a of the substrate 3 and the nozzle 11, the work of applying the sealant S is hardly affected by the shape of the application surface 3a of the substrate 3, and is highly versatile.

As described above, it is possible to provide the technique effective for easily applying the highly viscous sealant S to the application surface 3a of the substrate 3 according to the first embodiment.

In addition, according to the first embodiment, it is not necessary to prepare and use a sealing component such as a plug for each type of the opening 4, and thus, it is not necessary to provide many types of sealing components, and a component cost of the sealing component can be reduced.

Hereinafter, other embodiments related to the first embodiment will be described with reference to the drawings. In the other embodiments, the same elements as those of the first embodiment are denoted by the same reference signs, and description of the same elements will be omitted.

### Second Embodiment

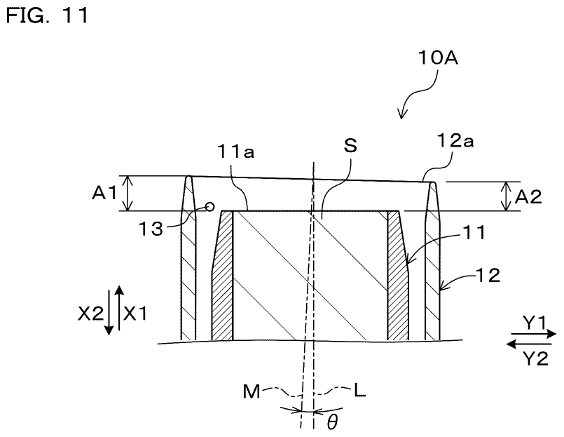

As shown in FIG. 11, in a second embodiment, a nozzle device 10A having a structure different from that of the nozzle device 10 of the first embodiment is used. Other configurations of the sealing facility 1 other than the nozzle device 10A are similar to those of the first embodiment.

In the nozzle device 10A, the nozzle 11 is arranged in an inclined state with respect to the guide member 12. That is, the axis line L of the nozzle 11 and a guide axis M of the guide member 12 form an inclination angle θ. In this case, a protruding height of the distal end portion 12a of the guide member 12 from the discharge port 11a of the nozzle 11 is different in the circumferential direction of the nozzle 11 in the structure. In FIG. 11, the nozzle device 10A is configured such that the protruding height becomes a maximum protruding height A1 on a slide start side of the wire 13 and a minimum protruding height A2 on a slide end side of the wire 13, and the protruding height changes between the maximum protruding height A1 and the minimum protruding height A2 according to a change in circumferential position.

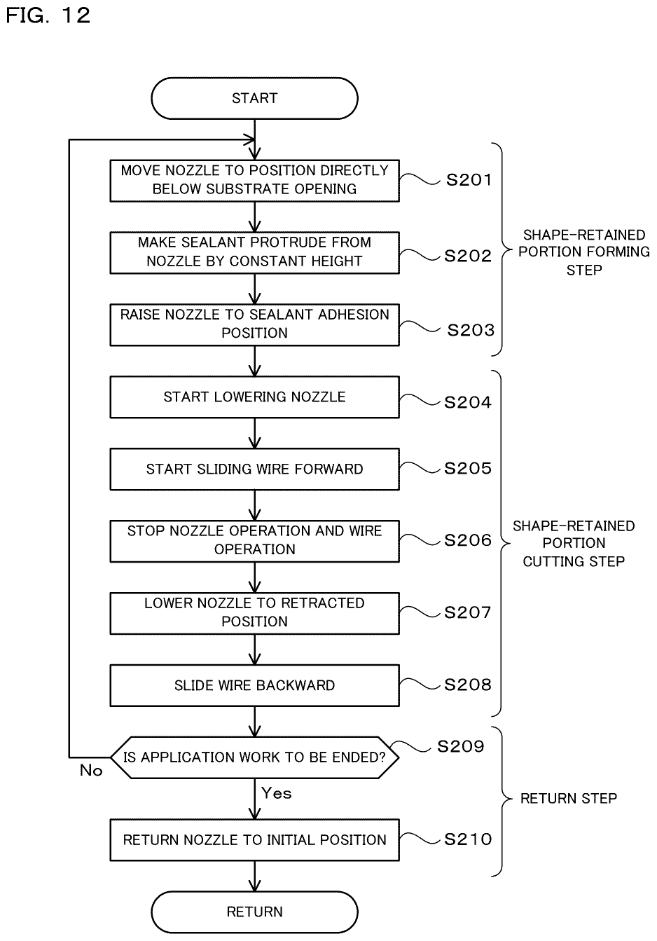

Next, an application method of the second embodiment will be described with reference to FIGS. 12 to 18. Similarly to the case of the first embodiment, this application method is roughly divided into a shape-retained portion forming step, a shape-retained portion cutting step, and a return step.

### (Shape-Retained Portion Forming Step)

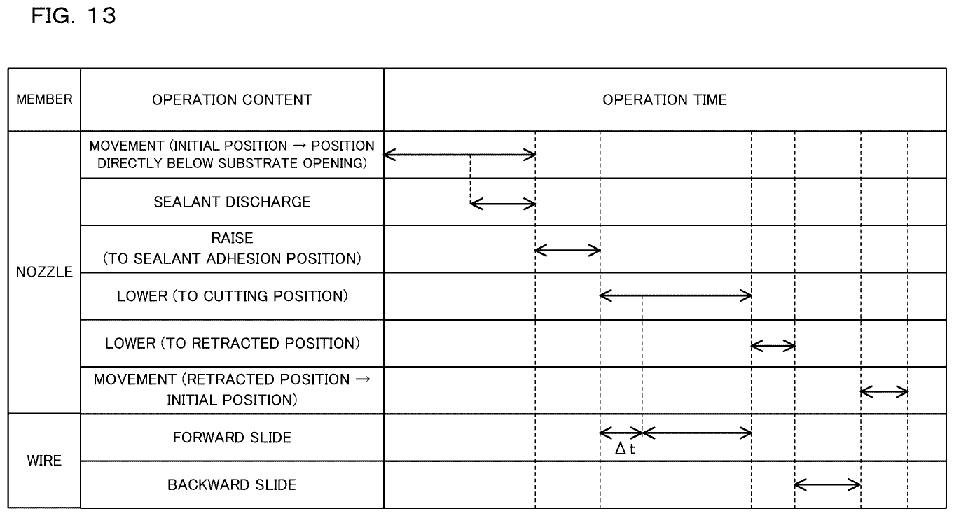

The shape-retained portion forming step can be performed by sequentially performing steps from a first step S201 to a third step S203 in FIG. 12 according to a time schedule in FIG. 13.

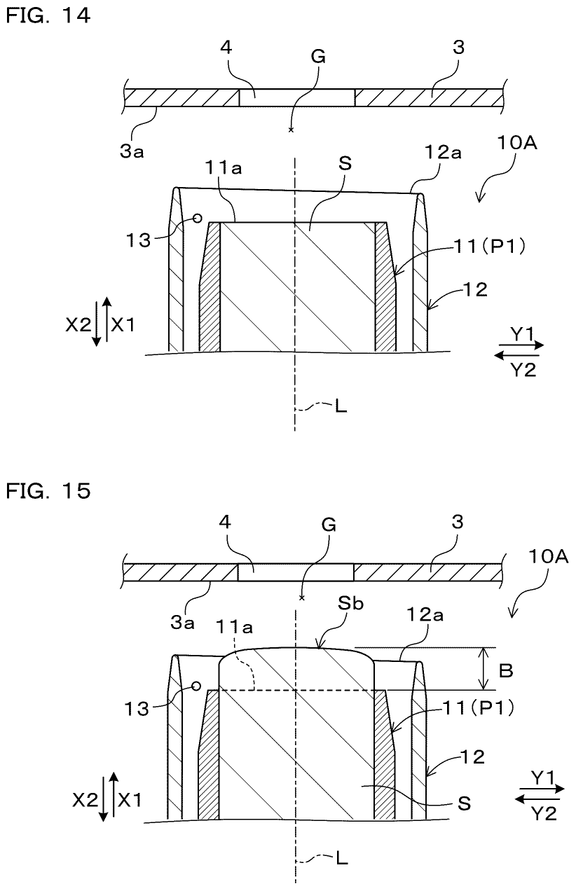

The first step S201 is a step of moving the nozzle 11 from an initial position (not shown) to the position P1 directly below the substrate opening in FIG. 14 by the robot control described above, which is similar to the first step S101 of the first embodiment. According to the first step S201, the nozzle 11 is arranged such that the axis line L of the nozzle 11 is perpendicular to the application surface 3a of the substrate 3 at the position P1 directly below the substrate opening. In addition, the second step S202 is a sealant discharging step of causing the seal ant S to protrude from the discharge port 11a of the nozzle 11 by a constant height, which is similar to the first step S101 of the first embodiment. As shown in the time chart of FIG. 13, it is preferable to shorten the time required to complete the second step S201 by executing the second step S202 before the nozzle 11 reaches the position P1 directly below the substrate opening in the first step S202.

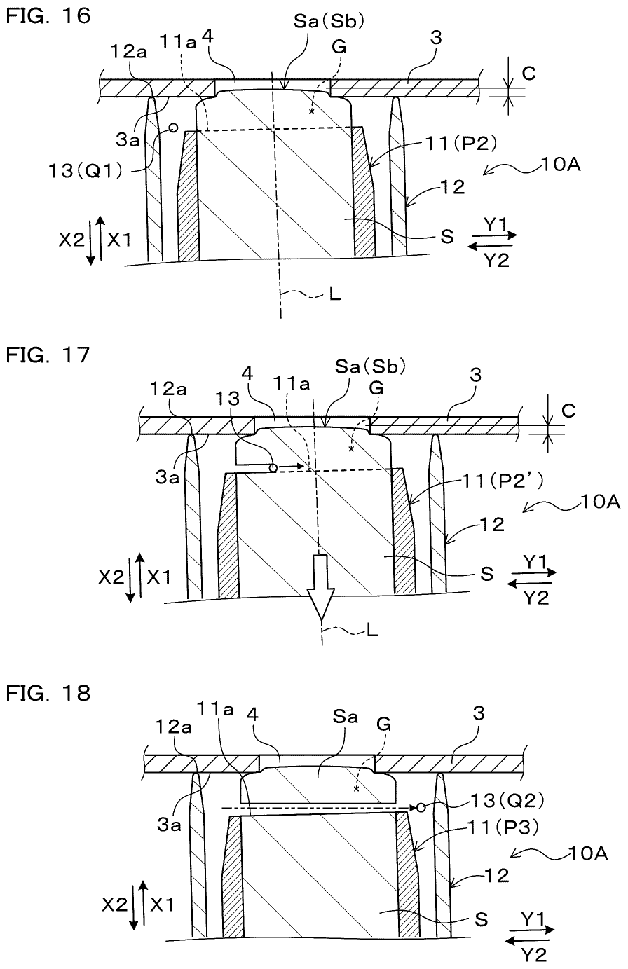

Following the second step S202, the third step S203 is a step of raising the nozzle 11 in the first direction X1 from the position P1 directly below the substrate opening in FIG. 15 to the sealant adhesion position P2 in FIG. 16 by the robot control described above. As shown in FIG. 16, in the third step S203, the distal end portion 12a of the guide member 12 abuts on the application surface 3a of the substrate 3, whereby the nozzle 11 is positioned with respect to the opening 4 of the substrate 3. At this time, the nozzle 11 is arranged such that the axis line L of the nozzle 11 is inclined at the inclination angle θ (see FIG. 11) with respect to the application surface 3a of the substrate 3 according to a structure of being inclined with respect to the guide member 12. In addition, when the nozzle 11 reaches the sealant adhesion position P2, the sealant S adheres to the application surface 3a of the substrate 3 in a state of entering the opening 4 by a protruding height C from the distal end portion 12a of the guide member 12, thereby forming the shape-retained portion Sa. As described above, according to the third step S203, the sealant S adheres to the application surface 3a in the inclined state in which the nozzle 11 is obliquely arranged with respect to the application surface 3a of the substrate 3 such that the gap G becomes maximum on the slide start side (first position Q1 side) of the wire 13, thereby forming the shape-retained portion Sa.

### (Shape-Retained Portion Cutting Step)

The shape-retained portion cutting step is a step after the shape-retained portion forming step, and can be performed by sequentially performing steps from a fourth step S204 to an eighth step S208 in FIG. 12 according to the time schedule in FIG. 13.

The fourth step S204 is a step of starting a lowering operation of lowering the nozzle 11 in the second direction X2 from the sealant adhesion position P2 in FIG. 16 to the cutting position P3 in FIG. 17 via an intermediate position P2′ in FIG. 18. At this time, the nozzle 11 is lowered in the second direction X2 along the axis line L of the nozzle 11 with respect to the guide member 12 in a state where abutment between the distal end portion 12a of the guide member 12 and the application surface 3a of the substrate 3 is maintained.

The fifth step S205 is a step of starting forward slide of the wire 13 after a predetermined time At (see FIG. 13) elapses since the fourth step S204. According to the fourth step S204 and the fifth step S205, a nozzle operation of the nozzle 11 and a wire operation of the wire 13 are performed in parallel, so that the shape-retained portion Sa can be gradually cut while increasing a tensile load applied to the shape-retained portion Sa. At this time, since the shape-retained portion Sa is cut while receiving the tensile load, the shape-retained portion Sa after the cutting can be prevented from recombining with the sealant S on the nozzle 11 side.

The sixth step S206 is a step of stopping both the nozzle operation in the fourth step S204 and the wire operation in the fifth step S205 at the timing when the nozzle 11 is lowered to the cutting position P3 in FIG. 18 and the wire 13 reaches the second position Q2 in FIG. 18. Through the sixth step S206, the shape-retained portion Sa separated from the nozzle 11 side remains on the substrate 3 side in the state of adhering to the application surface 3a of the substrate 3 similarly to the case of the first embodiment. At this time, the shape-retained portion Sa may be in the state of entering or not entering the opening 4 similarly to the case of the first embodiment.

Following the sixth step S206, the seventh step S207 is a step of lowering the nozzle 11 in the second direction X2 from the cutting position P3 to a retracted position (not shown) lower than the cutting position P3 in FIG. 18 by the robot control described above. The eighth step S208 is similar to the seventh step S107 of the first embodiment.

As described above, the shape-retained portion cutting step of the present embodiment is a step of sliding the wire 13 in the first direction Y1 crossing the discharge port 11a of the nozzle 11 with respect to the shape-retained portion Sa, formed in the shape-retained portion forming step, to cut the shape-retained portion Sa and causing the shape-retained portion Sa to remain on the application surface 3a side in the adhesion state similarly to the case of the first embodiment. In addition, in the shape-retained portion cutting step of the present embodiment, the nozzle operation of moving the nozzle 11 away from the application surface 3a of the substrate 3 and the wire operation of sliding the wire 13 forward in the first direction Y1 are performed in parallel and in an interlocking manner. The term “interlocking” as used herein refers to an embodiment in which the nozzle operation and the wire operation are interlocked so as to be reliably performed in parallel at the same timing.

### (Return Step)

The return step is a step after the shape-retained portion cutting step, and can be performed by sequentially performing a ninth step S209 and a tenth step S210 in FIG. 12 according to the time schedule in FIG. 13. The ninth step S209 and the tenth step S210 are similar to the eighth step S108 and the ninth step S109 of the first embodiment.

According to the second embodiment described above, the following operational effects can be obtained.

In the application method of the second embodiment, in the shape-retained portion forming step, the nozzle 11 is brought into the inclined state when the sealant S is discharged from the nozzle 11 toward the application surface 3a of the substrate 3. This inclined state is a state in which the nozzle 11 is obliquely arranged such that the gap G with the application surface 3a of the substrate 3 becomes maximum on the slide start side of the wire 13. Therefore, the shape-retained portion Sa is formed between the discharge port 11a of the nozzle 11 in the inclined state and the application surface 3a of the substrate 3. In the subsequent shape-retained portion cutting step, the wire operation of cutting the shape-retained portion Sa receiving the tensile load due to the nozzle operation by the wire 13 is performed while performing the nozzle operation of moving the nozzle 11 in the inclined state away from the application surface 3a of the substrate 3 along the axis line L of the nozzle 11. That is, the nozzle operation and the wire operation are performed in parallel. If the nozzle 11 is arranged such that the axis line L of the nozzle 11 is perpendicular to the application surface 3a of the substrate 3 when the nozzle operation and the wire operation are performed in parallel, a thickness of the shape-retained portion Sa that adheres to the application surface 3a of the substrate 3 and finally remains is thicker on the slide end side of the wire 13 than that on the slide start side of the wire 13. On the other hand, if the nozzle operation is performed with the nozzle 11 in the inclined state as described above, the shape-retained portion Sa having a constant thickness can be formed even when the nozzle operation and the wire operation are performed in parallel.

In addition, the similar operational effects as those of the first embodiment are obtained.

### Third Embodiment

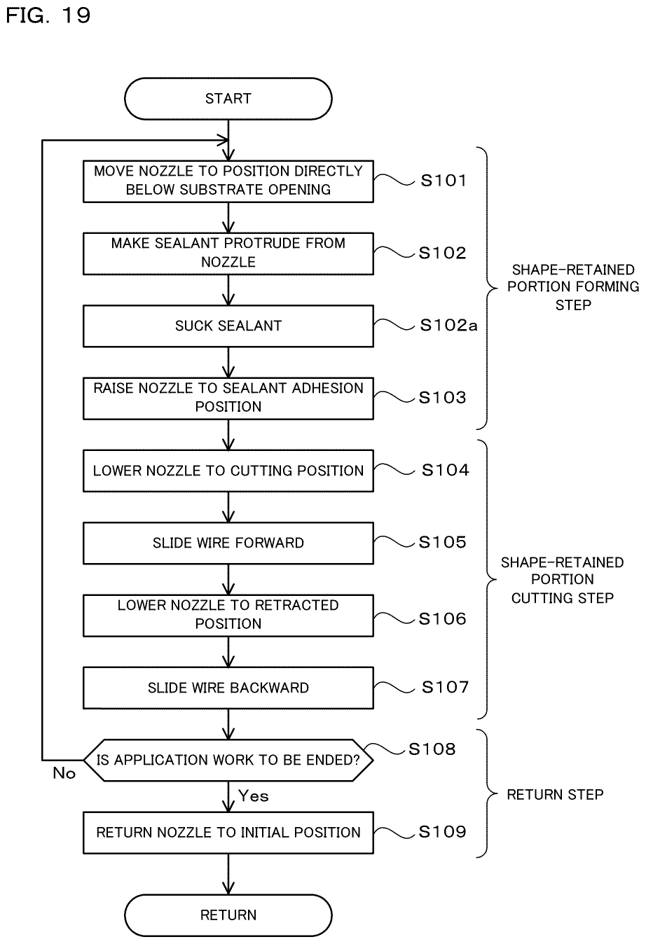

In a third embodiment, the nozzle device 10 of the first embodiment (see FIG. 2) is used. Similarly to the case of the first embodiment, an application method of the third embodiment is roughly divided into a shape-retained portion forming step, a shape-retained portion cutting step, and a return step. Hereinafter, the application method of the third embodiment will be described with reference to FIGS. 19 to 24.

### (Shape-Retained Portion Forming Step)

The shape-retained portion forming step can be performed by sequentially performing steps from a first step S101 to a third step S103 in FIG. 19.

The shape-retained portion forming step of the third embodiment is different from that of the first embodiment in that an additional second step S102a is added between the second step S102 and the third step S103. Note that the first step S101 is the same as that in the first embodiment, and thus the detailed description thereof will be omitted.

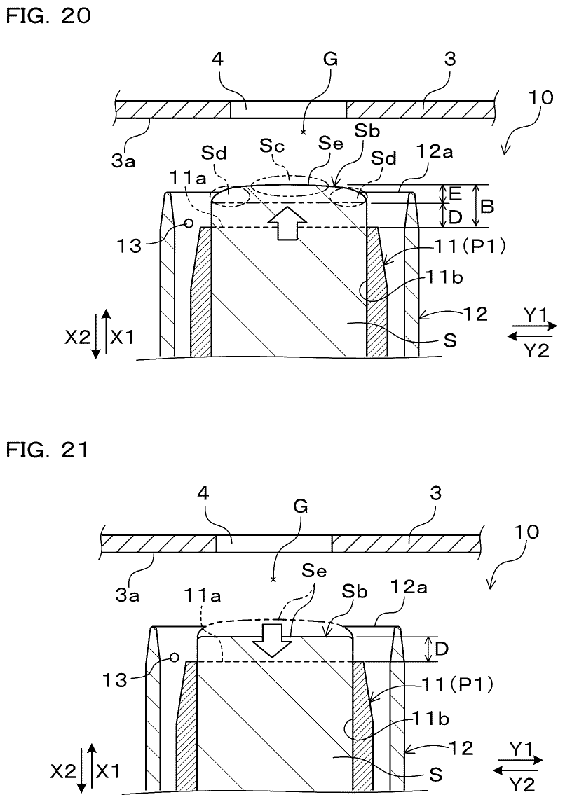

The second step S102 is a sealant discharging step of causing the sealant S to protrude from the discharge port 11a of the nozzle 11 by a constant height. As shown in FIG. 20, in the second step S102, the protruding height B is set on the basis of a planned protruding height D finally planned for the protrusion Sb of the sealant S. At this time, the protruding height B is set higher than the planned protruding height D, and has a height difference E from the planned protruding height D. Then, the above-described first operation of the pump 14 is executed to discharge the sealant S in the protruding direction X1 such that the protrusion Sb protrudes from the discharge port 11a of the nozzle 11 by the protruding height B. Note that operation conditions (for example, an operation time of the pump 14, a discharge pressure, and the like) at the time of the first operation of the pump 14 at this time are preferably set on the basis of results of test operations performed in advance while appropriately changing the operation conditions.

When the highly viscous sealant S is discharged in the protruding direction X1 in the second step S102, sticking resistance acts between the sealant S and an inner surface 11b of the nozzle 11. At this time, in the sealant S, a second portion Sd on the outer peripheral side of the nozzle is more easily affected by the sticking resistance than a first portion Sc closer to the center of the nozzle.

Therefore, in the second step S102, in the protrusion Sb of the sealant S, the first portion Sc first swells in the protruding direction X1, and the second portion Sd flows with a delay in the protruding direction X1. As a result, the protrusion Sb is formed to descend from the first portion Sc toward the second portion Sd. At this time, a front surface Se of the protrusion Sb is a curved surface protruding on the protruding side.

The additional second step S102a is a step of sucking the sealant S. As shown in FIG. 21, in the additional second step S102a, the above-described second operation of the pump 14 is performed to suck the sealant S in the suction direction X2 until the front surface Se of the protrusion Sb is in a flat state. Note that the timing at which the pump 14 is switched from the first operation to the second operation and operation conditions (for example, an operation time of the pump 14, a discharge pressure, and the like) during the second operation are preferably set on the basis of results of test operations performed in advance while appropriately changing the operation conditions.

When the highly viscous sealant S is sucked in the suction direction X2 in the additional second step S102a, in the protrusion Sb of the sealant S, the first portion Sc less affected by the sticking resistance is first drawn in the suction direction X2, and thus the degree of flow (a sinking amount) thereof is large. That is, in the protrusion Sb, the first portion Sc moves fast to return in the suction direction X2 and sinks greatly. On the other hand, the second portion Sd greatly affected by the sticking resistance in the protrusion Sb is drawn late in the suction direction X2, and thus the degree of flow thereof is small.

Therefore, according to the additional second step S102a, by using the sticking resistance acting between the highly viscous sealant S and the inner surface 11b of the nozzle 11, a shape of the protrusion Sb can be adjusted such that the protruding height of the protrusion Sb becomes the planned protruding height D, and the front surface Se of the protrusion Sb changes from a curved state (state indicated by the two-dot chain line in FIG. 21) to the flat state (state indicated by the solid line in FIG. 21).

The term “flat state” as used herein refers to a state in which the front surface Se of the protrusion Sb is a substantially flat surface. Therefore, the flat state also encompasses a state in which the front surface Se of the protrusion Sb includes minute unevenness.

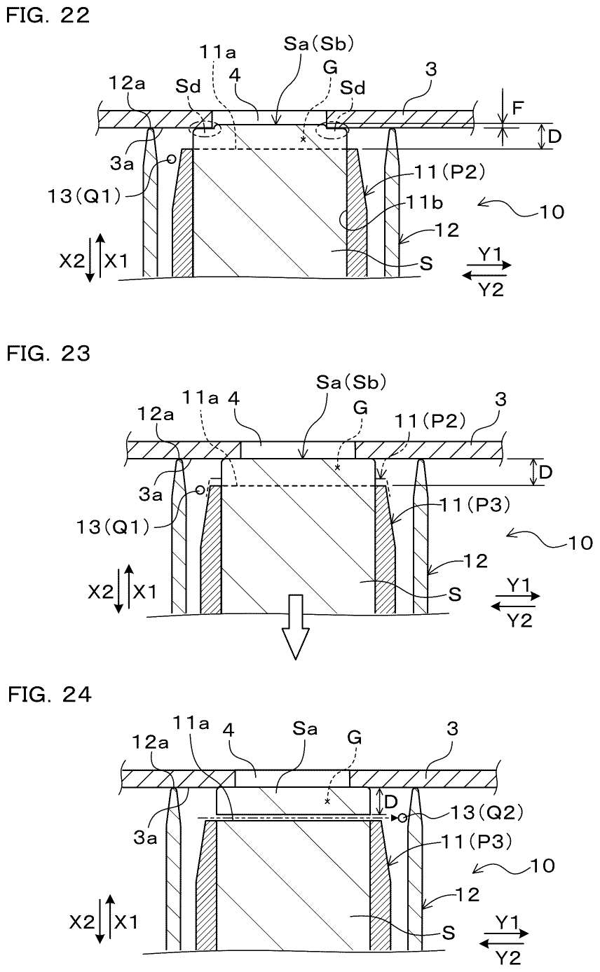

Similarly to the case of the first embodiment, the third step S103 is a step of raising the nozzle 11 from the position P1 directly below the substrate opening in FIG. 21 to the sealant adhesion position P2 in FIG. 22. According to the third step S103, the front surface Se of the protrusion Sb of the sealant S can be pressed against and attached to the application surface 3a of the substrate 3. Thus, the shape-retained portion Sa extending the protrusion Sb of the sealant S from the discharge port 11a of the nozzle 11 to the application surface 3a is formed.

However, in the third step S103 of the third embodiment, as shown in FIG. 22, the operation of raising the nozzle 11 is performed such that the protrusion Sb enters the opening 4 by a minute height difference F corresponding to a dimension of the descent of the second portion Sd. This enables the second portion Sd of the protrusion Sb of the sealant S to reliably adhere to the application surface 3a of the substrate 3. Note that the height difference F at this time is smaller than the height difference E (see FIG. 20).

### (Shape-Retained Portion Cutting Step)

The shape-retained portion cutting step can be performed by sequentially performing steps from the fourth step S104 to the seventh step S107 in FIG. 19.

As shown in FIG. 23, the fourth step S104 is a step of lowering the nozzle 11 from the sealant adhesion position P2 (position indicated by the two-dot chain line) to the cutting position P3 (position indicated by the solid line) similarly to the case of the first embodiment. According to the third step S103, when the nozzle 11 is lowered to the cutting position P3, the shape-retained portion Sa of the sealant S receives a tensile load corresponding to a lowering amount of the nozzle 11 and slightly extends until reaching the planned protruding height D.

As shown in FIG. 24, the fifth step S105 is a step of sliding the wire 13 forward from the first position Q1 (see FIG. 23) to the second position Q2 similarly to the case of the first embodiment. According to the fifth step S105, the shape-retained portion Sa is cut and separated from the nozzle 11 side. In the present embodiment, the shape-retained portion Sa remains on the substrate 3 side in the state of adhering to the application surface 3a of the substrate 3 with a constant thickness.

Since the other steps and processes are similar to those in the first embodiment, the detailed description thereof will be omitted.

According to the third embodiment described above, the following operational effects can be obtained.

In the application method of the third embodiment, when the highly viscous sealant S is discharged from the nozzle 11, the sticking resistance acts between the sealant S and the inner surface 11b of the nozzle 11. Therefore, the protrusion Sb of the sealant S is formed such that the first portion Sc closer to the center of the nozzle first swells in the protruding direction X1 and descends from the first portion Sc toward the second portion Sd on the outer peripheral side of the nozzle. Thereafter, the sticking resistance acts between the sealant S and the inner surface 11b of the nozzle 11 also when the sealant S is sucked. At this time, in the protrusion Sb of the sealant S, the first portion Sc is first drawn in the suction direction X2. Therefore, the degree of unevenness of the front surface Se of the protrusion Sb can be suppressed to be small, and adhesion performance of the sealant S when the front surface Se of the protrusion Sb is pressed against the application surface 3a of the substrate 3 can be improved.

In particular, in the present embodiment, the front surface Se of the protrusion Sb of the sealant S is pressed against the application surface 3a of the substrate 3 in the flat state. Thus, the adhesion performance of the sealant S can be further improved. In addition, since the front surface Se of the protrusion Sb of the sealant S is brought into the flat state, the protrusion Sb can be adjusted to the planned protruding height D (see FIG. 24) so as not to protrude too much from the discharge port 11a of the nozzle 11. Thus, cutting performance of the shape-retained portion Sa by the wire 13 can be stabilized, and cutting failure of the shape-retained portion Sa can be prevented.

In addition, according to the application method of the third embodiment, since the sealant S is sucked such that the front surface Se of the protrusion Sb is in the flat state, it is not necessary to excessively press the front surface Se of the protrusion Sb against a surface having an opening in order to secure desired sealing performance. That is, the protrusion Sb only needs to be pressed against the surface having the opening by the minute height difference F (see FIG. 21), and does not need to be pressed against the surface having the opening by the excessive height difference E (see FIG. 20) exceeding the height difference F. Thus, it is possible to suppress the sealant S from excessively entering and biting into the opening 4 of the substrate 3. Furthermore, since the protrusion Sb is suppressed from biting into the opening 4 of the substrate 3, the shape-retained portion Sa finally remaining on the application surface 3a side of the substrate 3 by cutting can be formed into a shape having a constant thickness and good appearance. As a result, the opening 4 of the substrate 3 can be closed with a minimum amount of the sealant S, a material cost of the sealant S can be reduced, and a weight increase of the substrate 3 can be suppressed.

In addition, the similar operational effects as those of the first embodiment are obtained.

Note that a characteristic portion of the shape-retained portion forming step of the third embodiment may be applied to the shape-retained portion forming step of the second embodiment.

Although the present disclosure has been described in accordance with the above-described embodiments, it is understood that the present disclosure is not limited to such embodiments and structures. The present disclosure also encompasses various modifications or alterations within the range of equivalents. In addition, various combinations and embodiments, as well as other combinations and embodiments, including those which include one or more additional elements, or those which include fewer elements are considered to fall within the scope and spirit of the present disclosure. For example, the following embodiments to which the above-described embodiments are applied can also be implemented.

In the embodiments described above, the case where the sealant S is discharged upward from the discharge port 11a of the nozzle 11 has been exemplified, but a discharging direction of the sealant S can be appropriately changed to a downward direction, a lateral direction, an obliquely upward direction, an obliquely downward direction, or the like in accordance with the shape, arrangement, or the like of the substrate 3.

In the embodiments described above, the case where the nozzle 11 is moved using the control of the robot has been exemplified, but instead of or in addition to this, the nozzle 11 may be moved using machine control, or a worker may directly hold and move the nozzle 11 with fingers.

In the embodiments described above, the technique of sealing the opening 4 of the substrate 3 constituting the underbody of the vehicle body 2 with the sealant S has been exemplified, but the sealed portion is not limited thereto, and this technique can also be applied to a technique of sealing an opening of a component constituting an element other than the underbody in the vehicle body 2 with the sealant S and a technique of sealing an opening provided in a component constituting an object other than the automobile with the sealant S.

In the embodiments described above, the application method of applying the sealant S to the application surface 3a, which is the surface having the opening of the substrate 3, has been exemplified, but it is a matter of course that this application method can be applied to a technique of applying the sealant S to a flat surface or a stepped surface.

1. A fluid application method for applying a highly viscous fluid to an application surface of a workpiece, the fluid application method comprising:
a shape-retained portion forming step of forming a shape-retained portion made of the fluid extended from a discharge port of the nozzle to the application surface by discharging the fluid from the nozzle, which is arranged in a position spaced from the application surface with a gap, to be adhered to the application surface; and
a shape-retained portion cutting step of cutting the shape-retained portion to be left in an adhesion state on the application surface side by sliding a wire toward the shape-retained portion formed in the shape-retained portion forming step in a transverse direction crossing the discharge port of the nozzle.

2. The fluid application method according to claim 1, wherein, in the shape-retained portion forming step, the fluid is discharged so as to have a protrusion protruded from the discharged port of the nozzle, thereafter, is sucked to allow the protrusion to flow in a suction direction, and a front surface of the protrusion is pressed against the application surface to have the application surface adhered thereto.

3. The fluid application method according to claim 2, wherein, in the shape-retained portion forming step, the fluid is sucked until the front surface of the protrusion reaches a flat state.

4. The fluid application method according to claim 1, wherein, in the shape-retained portion cutting step after forming the shape-retained portion, a nozzle operation of moving the nozzle away from the application surface of the workpiece along an axis line of the nozzle and a wire operation of sliding the wire in the transverse direction are performed in an interlocking manner.

5. The fluid application method according to claim 4, wherein
in the shape-retained portion forming step, the shape-retained portion is formed by adhesion of the fluid to the application surface in an inclined state in which the nozzle is obliquely arranged with respect to the application surface of the workpiece in such a manner that the gap becomes maximum on a side where the wire starts to slide, and
in the shape-retained portion cutting step, the nozzle operation and the wire operation are performed in parallel.

6. The fluid application method according to claim 1, wherein the application surface of the workpiece is a surface having an opening.
